(19) United States
(12) Patent Application Publication
(10) Pub. No.: US 2025/0108564 A1
(43) Pub. Date: Apr. 3, 2025

(54) Part Alignment in Additive Printing Process

(71) Applicant: TE Connectivity Solutions GmbH, Schaffhausen (CH)

(72) Inventors: Benjamin A. DOPP, Harrisburg, PA (US); Robert Frederick ZUBRICKIE, Harrisburg, PA (US); Yanzhe YANG, Hummelstown, PA (US)

(73) Assignee: TE Connectivity Solutions GmbH, Schaffhausen (CH)

(21) Appl. No.: 18/476,352

(22) Filed: Sep. 28, 2023

(51) Int. Cl. B29C 64/393; B29C 64/124; B33Y 10/00; B33Y 50/02; B33Y 80/00

(52) U.S. Cl. CPC B29C 64/393; B29C 64/124; B33Y 10/00; B33Y 50/02; B33Y 80/00

(57) ABSTRACT

A method of aligning a part in digital light processing printer and a part made therefrom. The method includes: establishing an absolute location of a pixel in an x/y plane; deriving a pixel boundary from the absolute location; aligning a three dimensional model with the pixel boundary across a build area of the printer; and printing the part using digital light processing. The part has a surface with a uniform surface morphology.

### FIELD OF THE INVENTION

The present invention relates to proper part alignment in an additive printing process. In particular, the invention relates to orienting parts to pixel boundaries to ensure that software adjustments are applied the same way to each part across the build area.

### BACKGROUND OF THE INVENTION

Additive manufacturing or three dimensional (3D) printers are in rapidly increasing use. 3D printers may include digital light process (DLP) printers and stereolithography (SLA) printers having a general principle of operation including the selective curing and hardening of radiation curable (photocurable) liquid resins. Such systems include a resin vessel holding the photocurable resin, a movement mechanism coupled to a support tray, and a controllable light engine. Three dimensional (3D) article of manufacture are formed by selectively curing layers of the photocurable resin onto a surface of the support tray. Each selectively cured layer is formed at a “build plane” within the resin.

In additive manufacturing/3D printing it is important to have layers and build areas aligned to avoid variation is parts. Large inter-part variation contributes to high scrap rates, additional dimensional inspection, and ultimately increases cost of printed parts. Current practice of additive printing is to support and locate parts to be printed using software. However, when printing multiple parts, the origin of each of the parts does not align with interpixel boundary. This results in software algorithms applying scaling, antialiasing and pixel shifting unevenly to models across the build area, and is one of the contributing factors of inter-part variation.

It would therefore be beneficial to provide a method to provide proper part alignment in an additive printing process. In particular, it would be beneficial to provide a method for orienting parts to pixel boundaries to ensure that software adjustments are applied in the same way to each part across the build area.

### SUMMARY OF THE INVENTION

An object of the invention is to orient parts to pixel boundaries to ensure that software adjustments are applied in the same way to each part across the build area.

An embodiment is directed to a method of aligning a part in digital light processing printer. The method includes: establishing an absolute location of a pixel in an x/y plane; deriving a pixel boundary from the absolute location; aligning a three dimensional model with the pixel boundary across a build area of the printer; and printing the part using digital light processing.

The absolute location may be established by selecting a respective pixel of digital light projector which is a light source for the digital light processing printer. A respective corner of the part may be aligned with the respective pixel.

One or more additional parts may aligned with the pixel boundary across the build area of the printer. The part may be printed from a photo curable material, such as, but not limited to, a photopolymer material. The part may be an electrical connector.

An embodiment is directed to a method of aligning layers of respective parts in digital light processing printer. The method includes: establishing absolute location of pixels in an x/y plane across a build area of the digital light processing printer; deriving pixel boundaries from the absolute locations; and printing pixelized slices of the parts across the build area, the pixelized slices positioned according to the pixel boundaries.

An embodiment is directed to a part made of photo curable material. The part has a surface with a uniform surface morphology. Surface morphology irregularities on the surface are aligned in the x-plane. Surface morphology irregularities may also be aligned in the y-plane. The surface morphology irregularities may be peaks and valleys which extend across the surface. The surface morphology irregularities are formed by the curing of the surface during digital light processing printing. The part may be an electrical connector.

Other features and advantages of the present invention will be apparent from the following more detailed description of the illustrative embodiment, taken in conjunction with the accompanying drawings which illustrate, by way of example, the principles of the invention.

### BRIEF DESCRIPTION OF THE DRAWINGS

FIG. 1 is a diagrammatic view of two parts which are positioned according to the method of the prior art, the parts are not precisely aligned.

FIG. 2 is an enlarged view of a respective cavity of a first part of the two parts of the prior art of FIG. 1.

FIG. 3 is an enlarged view of the same respective cavity of a second part of the two parts of the prior art of FIG. 1, the respective cavity of the first part and the respective cavity of the second part have different configurations due to the misalignment of the parts to the pixel of the light engine.

FIG. 4 is a picture of a non-pixel aligned surface of the part made according to the method of the prior art.

FIG. 5 is a diagrammatic view of two parts which are positioned according to the method of the present invention, the parts are precisely aligned to the pixel of the light engine.

FIG. 6 is an enlarged view of a respective cavity of a first part of the two parts of the present invention of FIG. 5.

FIG. 7 is an enlarged view of the same respective cavity of a second part of the two parts of the present invention of FIG. 5, the respective cavity of the first part and the respective cavity of the second part have the same configurations do to the precise alignment of the parts.

FIG. 8 is a picture of a pixel aligned surface of the part made according to the method of the present invention.

FIG. 9 is a flow chart of a first illustrative method of manufacturing a part according to the present invention.

FIG. 10 is a flow chart of a second illustrative method of manufacturing a part according to the present invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

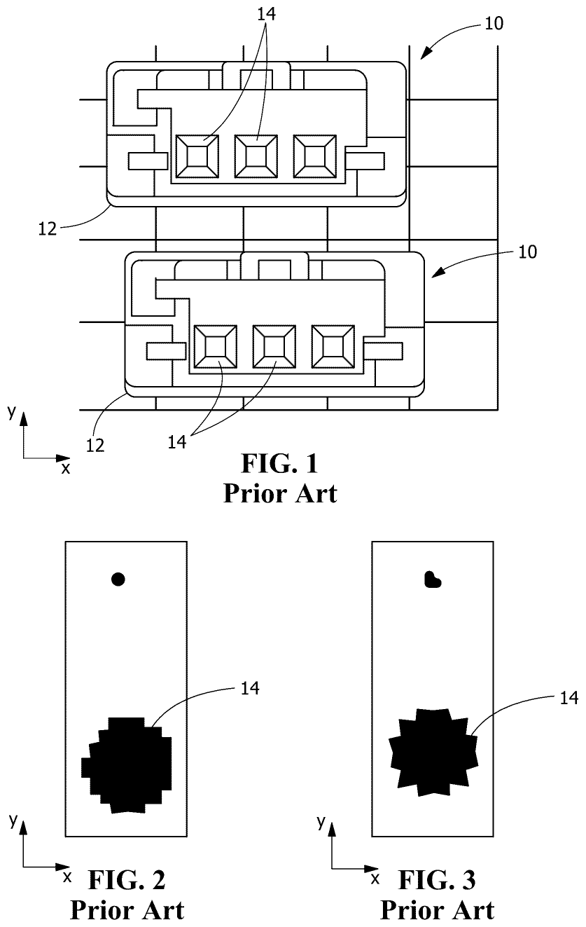

When using known additive processes, such as, but not limited to, digital light processing, to manufacture parts, such as electrical connectors, large inter-part variation contributes to high scrap rates, additional dimensional inspection, and ultimately increases cost of the printed parts. Current practice for digital light processing printing is to support and locate parts to be printed using software algorithms. However, when printing multiple parts, the origin of each of the parts do not align with an interpixel boundary, as shown in FIG. 1. This results in the software algorithms applying scaling, antialiasing and pixel shifting unevenly to models across the build, which is one of the contributing factors of inter-part variation.

Digital light processing (DLP) printing is a 3D stereolithography printing technology used to rapidly produce parts made of a photo curable material, such as, but not limited to, a photopolymer material. In the printing process, a DLP machine uses a projected light source to cure the entire layer. A part, such as, but not limited to, an electrical connector, is formed layer by layer.

The main components of a DLP 3D printer are the following: digital light source, digital micromirror device (DMD), vat (resin tank), the build plate and the elevator for the build plate.

The digital light source may be, but is not limited to, an arc lamp of a DLP printer at a wavelength of 385 to 405 nm. The DMD is a component which is made of thousands of micromirrors used for navigating the light beam generated by the light source. The vat is a tank for the resin which, for example, has a transparent bottom so that the light projected by the DMD reaches the resin and cures it. In some other cases, the light projected by the DMD reaches the resin and cures it at the top of the vat. The build platform is a substrate that the printed objects adhere to during printing that is moved by the movement mechanism along the z-axis for slowly moving the build platform during the printing process.

In use, a CAD model or other type of 3D model is used to manufacture the part. The 3D model is broken into 2D images, slices or layer. The 2D image that is projected is composed of pixels. The DLP projector flashes an image of a respective onto the build plate, causing all points of the respective layer of the part to be cured on the build plate. This process is repeated for each layer of the 3D model until the part is complete.

In the prior art, as shown in FIGS. 1 through 4, each part 10 manufactured using DLP printing is supported and located by using a software program or algorithm. Because of the complexity of the parts 10 and the mechanical properties of the system, when printing multiple parts, the origin 12 of each part 10 do not necessarily accurately align. This misalignment causes features, such as cavities 14, to be positioned at different x/y locations, as shown in FIGS. 2 and 3. This results in software algorithms applying scaling, antialiasing and pixel shifting unevenly across the build plate 16 and the part 10. This is one of the factors which causes large inter-part throughout the print.

In order to overcome the problems associated with the prior art, as shown in FIGS. 5 through 8, each part 50 manufactured using DLP printing is supported and located by using pixel boundaries. In this method, the CAD model of each part 50 is located so that the absolute location in the x/y plane aligns to a pixel boundary across the build plate. In the illustrative embodiment shown in FIGS. 5 through 8, the left-front corner of each part 50 is aligned to a pixel to establish the origin 52 or absolute location in the x/y plane (0,0). This alignment establishes the pixel boundaries in the x and y planes. However, in other illustrative embodiments, the absolute location in the x/y plane (0,0) may be positioned at other locations of the part 50, so long as the absolute location in the x/y plane (0,0) is the same of each part 50 of the multiple parts.

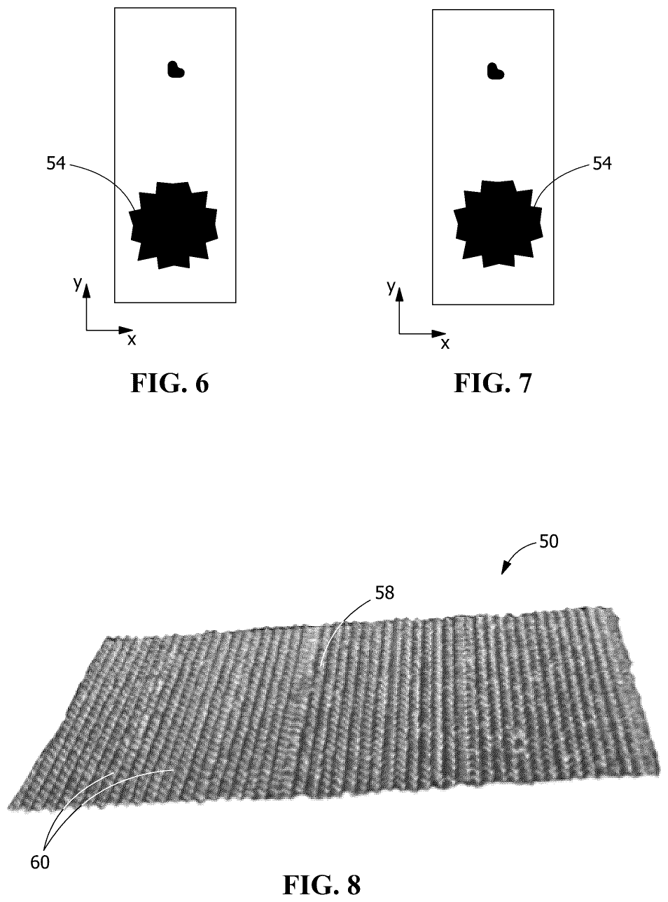

When printing multiple parts, the origin 52 of each part 50 is controlled and known, allowing each part 50 to be accurately aligned. As each part 50 is properly aligned, features, such as cavities 54, are positioned at the same x/y locations relative to the physical pixels, as shown in FIGS. 6 and 7. This minimizes the variation induces by software algorithms to scaling, antialiasing and pixel shifting across the build plate and the part 50, thereby eliminating or minimizing large inter-part variation between the multiple parts.

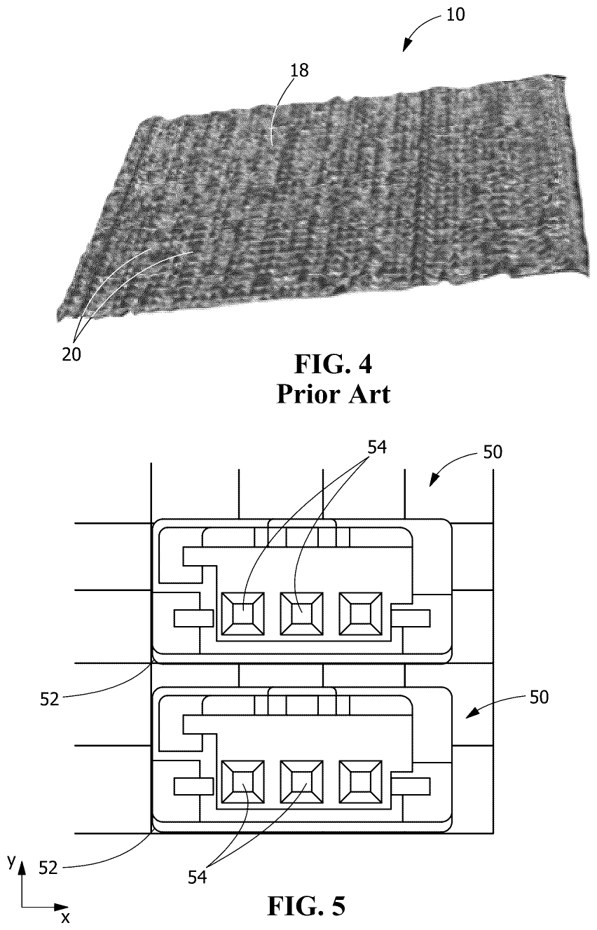

When parts are aligned according to pixel boundaries, a surface 58, such as an upper surface, of a part 50 has much more uniform or regular surface morphology (FIG. 8) when compared to the surface 18 of a part 10 which are not aligned according to pixel boundaries (FIG. 4). In the illustrative embodiment shown in FIG. 8, the peaks and valleys or the pixel marks 60 of the surface 58 are generally aligned in the x plane and in the y plane. In contrast, the peaks and valleys or the pixel marks 20 of the surface 18 of the prior art shown in FIG. 4 are not aligned in the x plane and in the y plane. The surfaces 58, 18 are shown using common optical inspection equipment at medium magnification (i.e. 80×), but other equipment at other magnifications may be used.

For example, an electrical connector made according to the present invention has an upper surface in which surface morphology irregularities created by the curing of the upper surface during digital light processing printing are aligned in the x-plane. In addition, the upper surface may have surface morphology irregularities aligned in the y-plane.

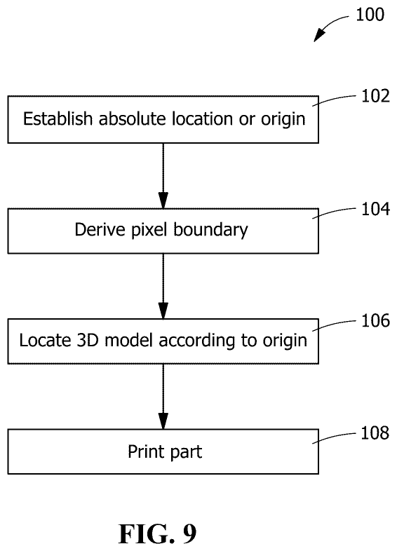

One illustrative embodiment of the method 100 of the present invention is shown in FIG. 9. As represented by 102, an absolute location or origin of a pixel in the x/y plane (0,0) is established. The origin allows the pixel boundary to be derived, as represented by 104. A three dimensional model, such as a CAD model, of the part is located according to the origin to align the model with the pixel boundary across the build area or plate, as represented by 106. The parts are then printed using digital light processing, as represented by 108.

When aligning respective parts in a digital light processing printer, the absolute location may be established by selecting a respective pixel of digital light projector which is a light source for the digital light processing printer. The respective pixel can define the pixel boundaries across a build area in the x plane and y plane. A respective corner of the respective part is aligned with the respective pixel allowing the respective part to be accurately printed using digital light processing printing.

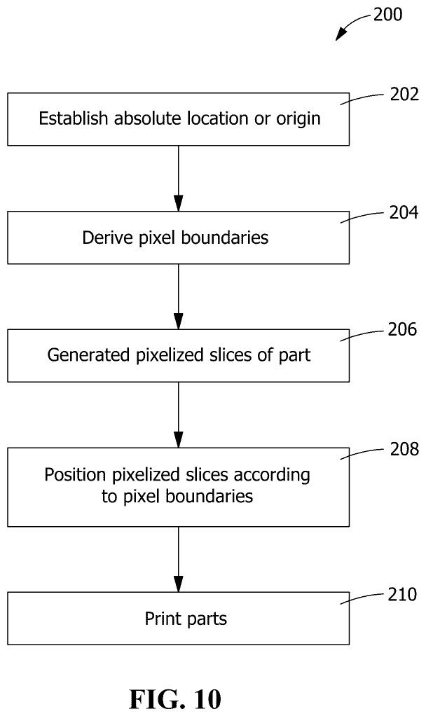

A second illustrative embodiment of the method 200 of the present invention is shown in FIG. 10. As represented by 202, absolute locations or origins of pixels in the x/y plane are determined across the build area or plate. The origins allow the pixel boundaries to be derived across the build area or plate, as represented by 204. Pixelized slices of the part are generated, as represented by 206. The pixelized slices are positioned according to the pixel boundaries, as represented by 208. The parts are then printed across the build area or plate by using digital light processing, as represented by 210.

When aligning respective layers of parts in a digital light processing printer, the absolute locations may be established by selecting respective pixels of digital light projector which is a light source for the digital light processing printer. The respective pixels can define the pixel boundaries across a build area in the x plane and y plane. Respective corners of the parts are aligned with the respective pixels allowing the respective layers to be accurately printed using digital light processing printing.

Orienting parts to pixel boundaries ensures that any software adjustments needed are applied in the same way to each part across the build area. Thereby ensuring that each part 50, and the components thereof, (i.e. the cavities 54), are duplicates of the other parts 50. The existing method of manufacture does not allow for such control.

While the invention has been described with reference to a preferred embodiment, it will be understood by those skilled in the art that various changes may be made, and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A method of aligning a part in digital light processing printer, the method comprising:
establishing an absolute location of a pixel in an x/y plane;
deriving a pixel boundary from the absolute location;
aligning a three dimensional model with the pixel boundary across a build area of the printer;
printing the part using digital light processing.

2. The method as recited in claim 1, wherein the absolute location is established by selecting a respective pixel of digital light projector which is a light source for the digital light processing printer.

3. The method as recited in claim 2, wherein a respective corner of the part is aligned with the respective pixel.

4. The method as recited in claim 1, wherein one or more additional parts are aligned with the pixel boundary across the build area of the printer.

5. The method as recited in claim 1, wherein the part is printed from a photo curable material.

6. The method as recited in claim 1, wherein the part is an electrical connector.

7. A method of aligning layers of respective parts in digital light processing printer, the method comprising:
establishing absolute location of pixels in an x/y plane across a build area of the digital light processing printer;
deriving pixel boundaries from the absolute locations;
printing pixelized slices of the parts across the build area, the pixelized slices positioned according to the pixel boundaries;

8. The method as recited in claim 7, wherein the absolute locations are established by selecting respective pixels of digital light projector which is a light source for the digital light processing printer.

9. The method as recited in claim 8, wherein respective corners of the layers are aligned with the respective pixels.

10. The method as recited in claim 7, wherein multiple layers for multiple parts are aligned with the pixel boundaries across the build area of the printer.

11. The method as recited in claim 7, wherein the layers are printed with a photo curable material.

12. The method as recited in claim 1, wherein the layers form one or more electrical connectors.

13. A part made of photo curable material, the part comprising:
a surface having uniform surface morphology.

14. The part as recited in claim 13, wherein surface morphology irregularities on the surface are aligned in the x-plane.

15. The part as recited in claim 14, wherein the surface morphology irregularities are aligned in the y-plane.

16. The part as recited in claim 14, wherein the surface morphology irregularities are peaks and valleys which extend across the surface.

17. The part as recited in claim 13, wherein the part is an electrical connector.

18. The part as recited in claim 14, wherein the surface morphology irregularities are formed by the curing of the surface during digital light processing printing.
